(19) United States
(12) Patent Application Publication
(10) Pub. No.: US 2011/0017695 A1
(43) Pub. Date: Jan. 27, 2011

(54) JACK-UP OFFSHORE PLATFORM AND A METHOD FOR ASSEMBLING AND SERVICING A WIND TURBINE

(75) Inventors: Luc VANDENBULCKE, Antwerpen (BE); Koen Vanderbeke, Erps-Kwerps (BE)

Correspondence Address: Jerold I. Schneider, 525 Okeechobee Blvd., Suite 1500, West Palm Beach, FL, 33401, US

(73) Assignee: GeoSea N.V., Zwijndrecht (BE)

(21) Appl. No.: 12/845,876

(22) Filed: Jul. 29, 2010

(30) Foreign Application Priority Data
Nov. 19, 2008 (EP) 08169404.4

(51) Int. Cl. B66C 23/18; B66C 13/18; B66C 23/72

(52) U.S. Cl. 212/279; 212/195; 212/270

(57) ABSTRACT

A jack-up offshore platform, on which is provided a lifting crane for lifting a load, which lifting crane includes structure connectable to the platform for counterbalancing the load. The counterbalancing structure may include at least one counterbalancing cable for operably connecting to the platform. A lifting crane provided with counterbalancing structure connectable to a jack-up offshore platform, and to a method of repositioning a load from a platform.

### CROSS REFERENCE TO RELATED APPLICATIONS

This application is based on European Patent Application No. 08169404.4, filed Nov. 19, 2008, which is hereby incorporated by reference in its entirety. Priority is not being claimed.

### FIELD OF THE INVENTION

The invention relates to a jack-up offshore platform, on which is provided a lifting crane for lifting a load, which lifting crane comprises counterbalancing means for counterbalancing the load. The invention also relates to a jack-up offshore platform, a lifting crane and to a method of repositioning a load from a jack-up offshore platform.

### BACKGROUND OF THE INVENTION

There is an increasing amount of large structures at sea that have to be serviced and repaired. A typical offshore wind turbine for instance comprises a nacelle supported by a tower of more than 100 meters high above sea level. A hub is connected to the nacelle for holding rotor blades, which can have a length of 70 meters and more. The nacelle alone typically accounts for 350 tons in weight. When assembling, servicing or repairing such large structures at sea, parts of the structure are generally transported to a jack-up offshore platform close to the structure, on which platform is provided a lifting crane for lifting the parts. The known platform comprises a lifting crane provided with a counterweight for counterbalancing the weight of the lifted parts. As structures become higher and larger, the required lifting cranes and counterweights become increasingly heavy, which consequentially also requires sturdier platforms. The counterweights moreover tend to take up more and more workspace from the jack-up offshore platform. Transporting large cranes and counterweights is also increasingly demanding and costly.

### SUMMARY OF THE INVENTION

It is an object of the invention to provide a more effective jack-up offshore platform for assembling or servicing large and high structures at sea. It is a further object to provide a method for repositioning a load as well as a method for assembling and servicing a wind turbine.

According to the invention, this object is achieved by a jack-up offshore platform, on which is provided a lifting crane for lifting a load, which lifting crane comprises counterbalancing means for counterbalancing the load, whereby the counterbalancing means are connectable to the jack-up offshore platform. When lifting a load, the counterbalancing means are connected to the jack-up platform. As a result, at least a part of the force carried by the counterbalancing means is transferred to the jack-up offshore platform, and the counterweight needed to counterbalance the load can be reduced compared to the state of the art, or even deleted altogether. Alternatively, a larger load can be lifted relative to the state of the art platform and crane.

An additional advantage of the jack-up offshore platform according to the invention is that its lifting crane takes up less space of the jack-up offshore platform and makes assembling or servicing structures at sea less expensive and easier to perform. Providing counterbalancing means that are, in operation, connected to the jack-up offshore platform has not been attempted before since lifting cranes usually move, in particular rotate, when repositioning a load. Connected counterbalancing means may limit the movement of the lifting crane. The advantages provided by a decreased counterweight and increased workspace are such however that a more effective jack-up offshore platform is achieved by the invention. With a more effective platform is meant a platform that is able to operate faster, easier and at reduced cost.

In a preferred embodiment of the invention, the counterbalancing means comprise at least one counterbalancing cable attached to the lifting crane and connectable to the platform. When lifting a load, the at least one counterbalancing cable transfers the counterbalancing forces into the jack-up offshore platform. As a result, strong counterbalancing means are obtained, which take up minimal workspace.

In another preferred embodiment, the counterbalancing means are connectable to the platform by first connection means provided on the cable, and second connection means provided on the jack-up offshore platform. The first and second connection means cooperate to achieve the connection. This embodiment allows for easy connecting and disconnecting of the counterbalancing cable to and from the jack-up offshore platform.

In yet another preferred embodiment, the counterbalancing means are connectable to the jack-up offshore platform at least two spaced apart connection positions. This allows to use the lifting crane in at least two different positions. For example, with the lifting crane in a first position, a load can be lifted from a cargo ship onto a particular location of the platform, and, with the lifting crane in a second position, the load can be repositioned to the structure at sea. In a simple, yet adequate embodiment, the counterbalancing means are connectable to the platform at two spaced apart connection positions. When servicing or assembling a structure at sea, such as a wind turbine, the lifting crane usually lifts parts from a first location, for example from a cargo ship or from the jack-up offshore platform, and positions the load at the preferred location of the structure. When these locations are at a substantial distance from each other, two spaced apart connection positions allow for effective use of the counterbalancing cables, whereas even more limited workspace of the jack-up offshore platform is used.

The second connection means can be located at any position of choice of the jack-up offshore platform. Preferably, the counterbalancing means are connectable to the platform nearby edges of the jack-up offshore platform. This saves even more workspace, as edges are usually not part of the workspace, or at least not used extensively.

In still another preferred embodiment, the counterbalancing means are movably connectable to the jack-up offshore platform. To establish such a movable connection between the counterbalancing means and the platform, the jack-up offshore platform may for instance comprise a guide, such as a cable-guide or a bar-guide, fixed to the platform. The first connection means may for instance be provided in the form of a hook that is connected to the cable-guide or bar-guide and will slide along the cable-guide or bar-guide when moving the lifting crane. A person skilled in the art may envisage other solutions to such a movable connection. The present embodiment does not demand or demands less connecting and disconnecting of the counterbalancing means during the use of the lifting crane. When moving the lifting crane, the connection between the counterbalancing means and the jack-up offshore platform can move relative to the platform, whereby the counterbalancing means can be used over a wider range of positions of the lifting crane. In case the counterbalancing means comprise a counterbalancing cable, it is also possible to provide a connection that is able to vary the length of the counterbalancing cable, or that is movable in the direction of the counterbalancing cable. This allows to accommodate movements of the lifting crane and/or to vary the stress in the cable according to the needs.

Although the off-shore jack-up platform, and in particular the lifting crane according to the invention does not need a counterweight, a preferred embodiment of the lifting crane comprises, in addition to the counterbalancing means, a counterweight, supported by the lifting crane. Such a lifting crane is able to move and rotate in its unconnected state (when it is not connected to the platform) in a number of stable configurations, eventually carrying a relatively small load. The counterweight of the present embodiment will typically be smaller than the counterweight of the known lifting crane, and therefore still saves weight and workspace. Preferably, the distance between the counterweight and the lifted load is adjustable. This results in a more flexible lifting crane, as the counterbalancing couple exerted by the counterweight about lifted load can be adjusted, resulting in easy repositioning of loads.

The lifting crane of the jack-up platform according to the invention preferably comprises at least one sensor for detecting forces, and control means for counterbalancing the load such that the lifting crane remains in equilibrium on the basis of the outcome of the detected forces. The detected forces for a certain load can be influenced by changing the position of the lifting crane and/or by tightening or loosening the counteracting cable, and/or eventually also by tightening or loosening other cables provided between different parts of the lifting crane. The sensors and control means may also be used to find an equilibrium position of the crane in which the force in the counterbalancing means is about zero. If the detected force in the counterbalancing cable for instance is below a predetermined low value, the counterbalancing cable may be disconnected from the platform without the crane loosing its equilibrium. This allows to safely reposition the lifting crane to another position. On the other hand, the sensors and control means may also be used to limit the stress in the counteracting cable to below a certain yield stress, in order to prevent fracture of the cable. The control means may also provide a signal, for example a sound or a light signal, to inform the user when a certain predetermined stress level is exceeded.

The lifting crane of the jack-up platform according to the invention is able to lift loads higher than the known platform lifting crane. The lifting crane of the jack-up platform is particularly useful for lifting loads to a height between 50 and 150 meter, preferably between 60 and 130 meter and most preferably between 70 and 110 meter above the jack-up offshore platform. A jack-up offshore platform on which is provided such a lifting crane is particularly advantageous, as counterbalancing forces may be high. The lifting capacity of the lifting crane according to the invention may easily be enlarged, for instance by increasing the thickness of the counterbalancing cables and/or the number thereof. More or larger counteracting cables are still easier to transport, lighter and take up less workspace than when using more or larger counterweights, as is done in the state of the art.

In yet another embodiment, the lifting crane comprises a first boom, movably supported by the jack-up offshore platform at its lower end, and a second boom, hingedly connected to the first boom, for holding the load. This allows for a more flexible lifting crane, as loads can be lifted higher, without a longer first boom. As a result, transport of the lifting crane with higher capacity in terms of height to and from the platform is still easy to perform.

Even more preferably, the lifting crane comprises a first boom, movably supported by the jack-up offshore platform at its lower end, and a third boom, provided to space apart the counterbalancing cable and the first boom. Connecting the counterbalancing cable indirectly to the first boom by a third boom enlarges the effective arm of the counterbalancing force and thereby the couple exerted about the first boom. As a result, higher loads can be lifted and/or the at least one counterbalancing cable as well as the first and second connection means can be designed more lightweight, which results in cheaper transport of the lifting crane.

The invention also provides a jack-up offshore platform comprising connection means for part of the counterbalancing means of a lifting crane. The jack-up offshore platform according to the invention allows for supporting a lifting crane without a counterweight, and thus can be designed smaller or may provide an increased workspace of the jack-up offshore platform.

The invention also relates to a method for repositioning a load from a jack-up offshore platform by a lifting crane provided with counterbalancing means for counterbalancing the load. The method comprises connecting a part of the counterbalancing means to the platform in a first connection position; lifting the load whereby the counterbalancing means counterbalance the load, positioning the load such that the counterbalancing means are essentially unloaded; disconnecting the counterbalancing means from the first connection position; repositioning the load such that the lifting crane remains in equilibrium; connecting the counterbalancing means to a second connection position, and repositioning the load whereby the counterbalancing means counterbalance the load, and unloading the load. The advantages of the method have already been elucidated in the context of describing the jack-up offshore platform above, and will not be repeated here.

The invention finally relates to the use of a jack-up offshore platform according to the invention for assembling and servicing structures at sea. Especially when transport of a lifting crane is needed the invention is advantageous, as no or at least a smaller counterweight is needed. In particular assembling high structures, such as wind turbines, and/or heavy structures can be performed more easily with the jack-up offshore platform according to the invention.

These and other aspects of the invention will be apparent from and elucidated with reference to the embodiment(s) described hereinafter.

### BRIEF DESCRIPTION OF THE DRAWINGS

The invention will now be explained in more detail with reference to the drawings, without however being limited thereto and wherein:

FIG. 1 shows an embodiment of the jack-up offshore platform according to the invention in side view; and

FIG. 2 shows a schematic top view of another embodiment of a jack-up offshore platform according to the invention.

### DETAILED DESCRIPTION

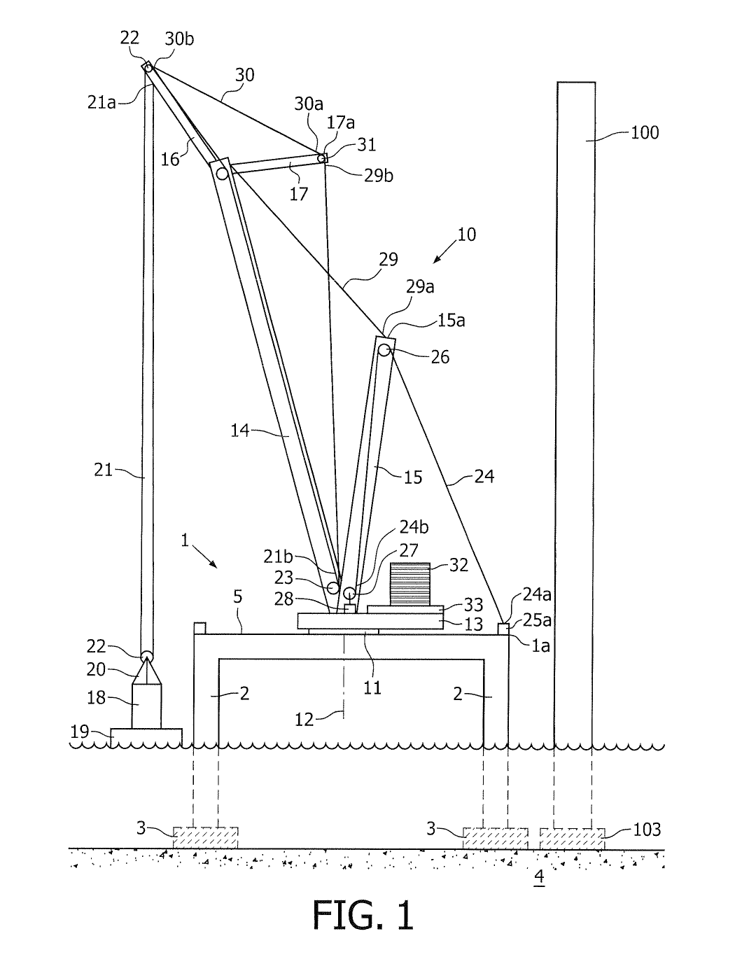

Referring to FIG. 1, a jack-up offshore platform 1 according to the invention is shown, located at sea nearby a semi-finished wind turbine 100, which is fixed by foundations 103 to a base 4. The jack-up offshore platform comprises supports 2, fixed by foundations 3 to the base 4, and a work deck 5. A lifting crane 10 is positioned on the work deck 5. The lifting crane 10 comprises a support 11, which allows for rotation of the lifting crane 10 relative to the jack-up offshore platform 1 about a vertical axis 12. The lifting crane furthermore comprises a frame 13. The frame 13 hingedly supports a first boom 14 and a second boom 15. A third boom 16 and a fourth boom 17 are hingedly supported nearby the top 14a of the first boom 14. A load 18, supported by a cargo ship 19, is connected to holding means 20 of the lifting crane 10. A lifting cable 21 is at a first end 21a connected to the third boom 16, guided over pulleys 22 and connected to a winch 23 at a second end 21b. The winch 23 is connected to the first boom 14 by a force sensor, which is not shown.

A counterbalancing cable 24 is at its first end 24a connected to a first eyelet 25a, which first eyelet 25a is rigidly fixed to the jack-up offshore platform 1, nearby an edge 1a of the jack-up offshore platform 1. The cable 24 is guided over a pulley 26, fixed to the top 15a of the second boom 15 and connected to a winch 27 at a second end 24b. The winch 27 is connected to a force sensor 28, which force sensor is fixed to the frame 13 of the lifting crane 10, A first control cable 29 is at its first end 29a connected to the second boom 15 by a winch, which is not shown, nearby the pulley 26. At a second end 29b the first control cable 29 is fixed to an end 17a of the fourth boom 17. A second control cable 30 is at its first end 30a connected to the end 17a of the fourth boom 17 by a winch 31. At a second end 30b the cable 30 is fixed to an end 16b of the third boom 16. In addition, the lifting crane 10 comprises a counterweight 32, which is movably connected to the frame 13 by a support 33. The support 33 allows displacement the counterweight 32 closer to and further away from the lower end 14b of the first boom 14. Preferably, the force sensor 28 is connected to a control system, which controls at least the winches 23,27,31 as a result of the level of the detected force.

When lifting the load 18, the load will exert a couple about a lower end 14b of the first boom 14b. Both the counterbalancing cable 24 in cooperation with the first control cable 29, as well as the counterweight 32 will exert a counterbalancing couple about the lower end 14b of the first boom 14. As a result the first boom 14 is in moment equilibrium. If the first boom 14 and the third boom 16 are oriented with higher inclination, the couple exerted about the lower end 14b of the first boom 14 will decrease. As a result the counterbalancing force in the counterbalancing cable 24 and the first control cable 29 will decrease, and, if the inclination of the first boom 14 and the third boom 16 increase sufficiently, the counterbalancing cable 24 and/or the first control cable 29 may even become slack, as the counterweight 32 is able to counterbalance the decreased couple exerted by the lifted load 18 about the lower end 14a of the first boom 14. The counterbalancing cable 24 may now be disconnected from the first eyelet 25a. With the first boom 14 and the third boom 16 in the inclined orientation, the lifting crane 10 may be rotated about the axis 12, e.g. by 180°. After connecting the counterbalancing cable 24 to a second eyelet 25b, the third boom 16 and/or the first boom 14 may be lowered to position the load 18, e.g. a nacelle, on the semi-finished wind turbine 100. During lowering the third boom 16 and/or the first boom 14 the counterbalancing force in the counterbalancing cable 24 and the first control cable 29 will increase.

In another embodiment, the first boom 14 of the lifting crane 10 does not comprise a third boom 16 or a fourth boom 17. In that case, the first control cable 29 is connected to the top 14a of the first 14 at its first end 29a.

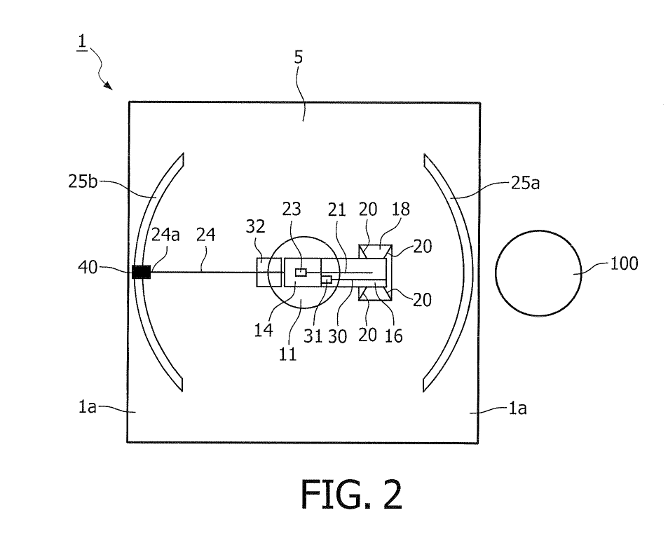

Now referring to FIG. 2, a top view on another embodiment of the jack-up offshore platform 1 according to the invention is shown. The jack-up offshore platform 1 of FIG. 2 differs from the platform of FIG. 1 in that the first and second eyelets 25a,25b are replaced by first and second bar-guides 25a,25b. The counterbalancing cable 24 is connected to the second bar-guide 25b at its first end 24a by a hook 40. The first boom 14 as well as the third boom 16 is in an almost upright position, wherein the load 18 is counterbalanced by the counterweight 32. As the counterbalancing cable 24 is connected to the second bar-guide 25b, both the first boom 14 as well as the third boom 16 may be lowered, wherein during lowering counterbalancing force in the counterbalancing cable 24 will increase. Rotation of the lifting crane 10 about the axis 12, see also FIG. 1, without the need of disconnecting and connecting the counterbalancing cable 24, is made possible, as the curved second bar-guide 25b allows for sliding of the hook 40, depending on the orientation of the lifting crane 10.

While the invention has been illustrated and described in detail in the drawings and foregoing description, such illustration and description are to be considered illustrative or exemplary and not restrictive; the invention is not limited to the disclosed embodiments and those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A jack-up offshore platform, comprising a lifting crane for lifting a load and counterbalancing means for counterbalancing the load, wherein the counterbalancing means are connected to the platform.

2. A jack-up offshore platform according to claim 1, wherein the counterbalancing means comprise at least one counterbalancing cable attached to the lifting crane and connected to the platform.

3. A jack-up offshore platform according to claim 2, wherein the counterbalancing cable is connected to the platform through first connection means provided on the cable, and second connection means provided on the jack-up offshore platform.

4. A jack-up offshore platform according to claim 1, wherein the counterbalancing means are connected to the platform at least two spaced apart connection positions.

5. A jack-up offshore platform according to claim 4, wherein the counterbalancing means are connected to the platform at two spaced apart connection positions.

6. A jack-up offshore platform according to claim 1, wherein the counterbalancing means are connected to the platform nearby edges of the jack-up offshore platform.

7. A jack-up offshore platform according to claim 1, wherein the counterbalancing means are movably connected to the jack-up offshore platform.

8. A jack-up offshore platform according to claim 1, wherein the lifting crane in addition to the counterbalancing means comprises a counterweight, supported by the lifting crane.

9. A jack-up offshore platform according to claim 1, wherein the lifting crane comprises at least one sensor for detecting forces and control means for counterbalancing the load such that the lifting crane remains in equilibrium, on the basis of the outcome of the detected forces.

10. A jack-up offshore platform according to claim 1, wherein the lifting crane is suitable for lifting loads to a height between 50 and 150 meter, preferably between 60 and 130 meter and most preferably between 70 and 110 meter above the jack-up offshore platform.

11. A jack-up offshore platform according to claim 1, wherein the lifting crane comprises a first boom, movably supported by the jack-up offshore platform at its lower end, and a second boom, hingedly connected to the first boom, for holding the load.

12. A jack-up offshore platform according to claim 1, wherein the lifting crane comprises a first boom, movably supported by the jack-up offshore platform at its lower end, and a third boom, provided to space apart the counterbalancing cable and the first boom.

13. A jack-up offshore platform, comprising a lifting crane and connection means for connecting the counterbalancing means of the lifting crane.

14. A jack-up offshore platform according to claim 13, comprising connection means for connecting at least one counterbalancing cable attached to the lifting crane to the platform.

15. Method for repositioning a load from a jack-up offshore platform by a lifting crane provided with counterbalancing means for counterbalancing the load, the method comprising:
connecting the counterbalancing means to the crane, and to the platform in a first connection position;
lifting the load whereby the counterbalancing means counterbalance the load,
positioning the load such that the counterbalancing means are essentially unloaded;
disconnecting the counterbalancing means from the first connection position;
repositioning the load such that the lifting crane remains in equilibrium;
connecting the counterbalancing means to a second connection position, and
repositioning the load whereby the counterbalancing means counterbalance the load, and
unloading the load.

16. Method according to claim 15, wherein the counterbalancing means comprise at least one counterbalancing cable attached to the lifting crane and connected to the platform.

17. Method according to claim 16, wherein the counterbalancing cable is connected to the platform through first connection means provided on the cable, and second connection means provided on the jack-up offshore platform.

18. Method according to claim 15, wherein the counterbalancing means are connected to the platform at least two spaced apart connection positions.

19. Use of a jack-up offshore platform according to claim 1 for assembling and servicing a structure at sea.
